(19) United States
(12) Patent Application Publication
(10) Pub. No.: US 2022/0034403 A1
(43) Pub. Date: Feb. 3, 2022

(54) SEAL ASSEMBLIES HAVING A SENSOR

(71) Applicant: Hewlett-Packard Development Company, L.P., Spring, TX (US)

(72) Inventors: Arturo GARCIA GOMEZ, Sant Cugat del Valles (ES); Ruben PRATS GONZALEZ, Sant Cugat del Valles (ES); Josep Maria FERNANDEZ SANJUAN, Sant Cugat del Valles (ES)

(73) Assignee: Hewlett-Packard Development Company, L.P., Spring, TX (US)

(21) Appl. No.: 17/299,255

(22) PCT Filed: Apr. 25, 2019
(86) PCT No.: PCT/US2019/029081

§ 371 Date: Jun. 2, 2021

(51) Int. Cl. F16J 13/24; B07B 1/06; B22F 10/20; B29C 64/255; F16J 15/06; B29C 64/357; B22F 10/70

(52) U.S. Cl. CPC F16J 13/24; B07B 1/06; B22F 10/20; B33Y 30/00; F16J 15/064; B29C 64/357; B22F 10/70; B29C 64/255

(57) ABSTRACT

Examples relate to a seal assembly comprising a base unit comprising an opening and a sealing surface extending around the opening. The seal assembly further comprises a sensor to detect a distance between the sealing surface of the base unit and a sealing surface of a lid when a fastener is connecting the lid to the base unit.

### BACKGROUND

Additive manufacturing techniques, such as three-dimensional (3D) printing, relate to techniques for making three-dimensional objects from a digital three-dimensional model through additive processes. In some additive manufacturing techniques, three-dimensional objects may be generated on a layer-by-layer basis by fusing a build material. When a build process completes, a non-fused build material may be recovered after generating a three-dimensional object.

### BRIEF DESCRIPTION OF THE DRAWINGS

Various example features will be apparent from the detailed description which follows, taken in conjunction with the accompanying drawings, wherein:

FIG. 1 schematically illustrates a cross sectional view of an example of a seal assembly according to the present disclosure.

FIG. 2 schematically illustrates a bracket for holding a sensor according to an example of the present disclosure.

FIG. 3 schematically illustrates an adjustable sensor bracket of the bracket according to FIG. 2.

FIG. 4 schematically illustrates an example of a sieve assembly according to the present disclosure.

FIG. 5 schematically illustrates an upper view of the sieve assembly of FIG. 4.

FIG. 6 schematically illustrates a housing and a plurality of sensors of an example of a sieve assembly according to the present disclosure.

FIG. 7 schematically illustrates a cross-sectional view of a portion of a sieve assembly according to one example of the present disclosure.

### DETAILED DESCRIPTION

3D or 3-D printing are acronyms that refer to three-dimensional printing. These terms are interchangeably used in this disclosure. In some 3D printing techniques a build material in the form of a particle material, e.g. powder-like materials, may be deposited layer-by-layer inside a 3D build unit and may be selectively fused to generate a three-dimensional object. Non-fused build material may be left over after a build process. After a build process completes, a build object, i.e. a three-dimensional object, is removed from the non-fused build material.

Non-fused build material, e.g. non-fused powder, may be recovered from a 3D build unit in which a 3D object has been generated. Recovering a build material may involve processing the non-fused build material. For example, a recovered build material may be sieved to remove any semi-fused or conglomerated portions of the recovered build material. After processing, the recovered build material may be used as a build material to generate a 3D object. In some examples, the recovered or recycled build material may be mixed with fresh build material before generating the 3D object.

A recovered build material may be sieved by using a sieve assembly. In some examples, fresh build material may be sieved or filtered to ensure that particles of the fresh build material have a predetermined size. Build material may be loaded into the sieve assembly and may pass through a sieve having apertures, e.g. formed by a mesh or an aperture plate, to allow build material having a predetermined maximum particle size to pass through the sieve and particles with larger size not to pass through. Any conglomerated build materials or any other contaminants having a size larger than the biggest apertures may be either broken down by the sieve and then they pass through it or stopped from passing through the sieve.

The sieve may be placed inside a housing of a sieving assembly. A sieving process may be performed inside the sieving assembly in a closed environment.

A build unit refers to a unit in which a 3D object may be generated. In some examples, a build unit may be removable from a 3D printer. In other examples, a build unit may be integrated into a 3D printer.

FIG. 1 schematically illustrates a cross sectional view of an example of a seal assembly 10 according to the present disclosure. The seal assembly 10 comprises a base unit 20 comprising an opening 22 and a sealing surface 21 extending around the opening 22. The seal assembly 10 further comprises a sensor 40 to detect a distance between the sealing surface 21 of the base unit 20 and a sealing surface 31 of a lid 30 when a fastener (not illustrated in FIG. 1) is connecting the lid 30 to the base unit 20.

The sensor 40 may thus detect if the lid 30 has been correctly attached to the base unit 20. Material inside the base unit may be prevented from leaving the base unit through the opening 22. A tightened connection between lid 40 and the base unit 20 may thus be established. The base unit may be sealed by approaching the sealing surface 21 of the base unit 20 to the sealing surface 31 of the lid 30.

In some examples, the sealing surface 21 of the base unit 20 may contact the sealing surface 31 of the lid 30 when a fastener connects the lid to base unit. In some examples, a seal member may be placed between the sealing surfaces. A seal member may be pressed between the sealing surfaces when a fastener connects the lid 30 to the base unit 20. The seal member may be compressed between the sealing surfaces by a pressure applied by the fastener.

In some examples, the sensor 40 may be attached to an outer surface 29 of the base unit. The sensor may thus be protected from a material contained inside the base unit. The sensor may be mounted in a bracket to be attached to the base unit. In other examples, the sensor may be placed on an inner side 28 of the base unit.

In some examples, the sensor 40 may detect a distance between the sealing surfaces by measuring a distance between the sealing surfaces. In some examples, the distance between the sealing surfaces may be zero or about zero. The sensor 40 may thus detect that the sealing surfaces are in contact and the base unit may accordingly be correctly sealed.

In some examples, e.g. where a seal member is between the sealing surfaces, the sensor 40 may measure a distance between the sealing surfaces which may indicate if the based unit 20 and the lid 30 are correctly attached. The distance between the sealing surfaces may depend on the compression of the seal member caused by the force exerted by the fastener.

A distance between the sealing surfaces below a predetermined distance may indicate that a sealed connection is established. The predetermined distance may be a distance between the sealing surfaces in which particles of a material inside the base unit are prevented from leaving through the opening. For example, the predetermined distance may depend on the size of particles of the material inside the base unit. Smaller particles may involve a higher sealing effect and therefore the predetermined distance may be smaller.

In some examples, the sensor 40 may detect a distance between the sealing surfaces by measuring the distance between the sensor 40 and the sealing surface 31 of the lid 30 when attached to the base unit 20. Between the sealing surface 21 of the base unit 20 and the sensor 40 may be an offset to position the sensor 40 below a level of the sealing surface 21 of the base unit 20. The distance between the sealing surfaces may thus be the distance between the sealing surface 31 of the lid 30 and the sensor 40 minus the offset.

In some examples, the sensor 40 may detect a distance by contacting the sealing surface 31 of the lid 30 when attached to the base unit 20. For example, a sensor 40, e.g. a contact sensor, may be mounted at a level of the sealing surface 21 of the base unit 20 to contact the sealing surface 31 of the lid 30 when the two sealing surfaces are in contact.

A sensor 40, e.g. a contact sensor, may be positioned at an offset distance above a level of the sealing surface 31 of the base unit 20. This offset may be adjusted to the predetermined distance to ensure that a sealed connection is established. For example when a seal member is placed between the sealing surfaces, a contact sensor may be positioned above the sealing surface 21 of the base unit 20 to contact the sealing surface 31 of the lid 30 when the distance between the sealing surfaces is lower than a predetermined distance. A distance between the surfaces may thus be detected by contacting the sensor 40 with the lid.

In some examples, the sensor may be a proximity sensor or a contact sensor. Proximity sensors are sensors able to detect a presence of nearby objects with no physical contact. Examples of proximity sensors to detect a distance between the sealing surfaces may be capacitive sensors, inductive sensors, optical sensors or laser sensors. Contact sensors are sensors able to detect a presence of an object by contacting this object. A contact sensor may be a touch switch or a limit switch which is a switch operated by the presence of an object. Miniature snap-action switches are examples of touch or limit switches. Miniature snap-action switches may also be called as micro switches. A miniature snap-action switch is an electric switch in which a relatively small movement at an actuator causes a relatively large movement at the electrical contacts. Accordingly, a contact between the lid and an actuator of a miniature snap-action switch changes the position of the electrical contacts and a distance below a predetermined distance between the sensor and the sealing surface of a lid may thus be detected.

In some examples, the sensor, may detect a separation between the lid and the base unit of less than 1 millimeter. In some examples, the sensor may detect a separation of less than 0.1 millimeters between the lid and the base unit. For example a miniature snap-action switch may detect a distance between the lid and the base unit of less than 0.1 millimeters.

In some examples, the sealing assembly may comprise a plurality of sensors. The plurality of sensors may be distributed along the joint to determine the distance between the sealing surfaces in several positions.

In some examples, a controller may receive a signal from the sensor to determine if the detected distance is above a predetermined distance, i.e. to determine if a lid is not correctly attached to base unit. The controller may also send a signal to for example a user interface device to indicate that the connection between the base unit and the lid is not correctly sealed.

A fastener according to the present disclosure may be a screw or a clamp. Examples of screws may be a bolt, a threaded rod and a threaded insert. In some examples the base unit may include a fastening portion to receive the fastener, e.g. a threaded hole to screw the fastener. The screws may include a knob or a handle to facilitate securing a screw on a threaded hole. The screws may be torque limiting screws which provide a predetermined torque. In some examples, the fastener may be a torque limiting knob.

In some examples, a plurality of fasteners may be used to connect a lid to the base unit. Accordingly, the base unit may comprise a plurality of fastening portions, e.g. threaded holes, to receive the fasteners.

In other examples, the base unit may comprise a threaded perimeter in which a cap screw of the lid may be screwed.

The base unit may contain a powder-based material. The seal assembly may thus avoid a leakage of powder. The seal assembly may isolate the powder from an outside the base unit.

Equipments and facilities using powder may involve complying with ATEX directive. ATEX directive describes what equipment and work space is allowed in an environment with an explosive atmosphere. Depending on the probability of having an explosive atmosphere in the form of a cloud of combustible dust in air, several category zones may be established. Avoiding leakage of powder from the base unit, the probability of having an explosive atmosphere in the form of a cloud combustible in equipments and facilities surrounding the base unit may be reduced. Therefore, these equipments and facilities may be subjected to a less strict category zone or even not subjected to the ATEX directive. These surrounding equipments and facilities may thus be more cost-effective and safety may also be increased.

In some examples, the base unit may be a housing of a sieve assembly. A sieve to sieve powder may be provided inside the base unit. The seal assembly may be incorporated in any of the examples of a sieve assembly herein disclosed.

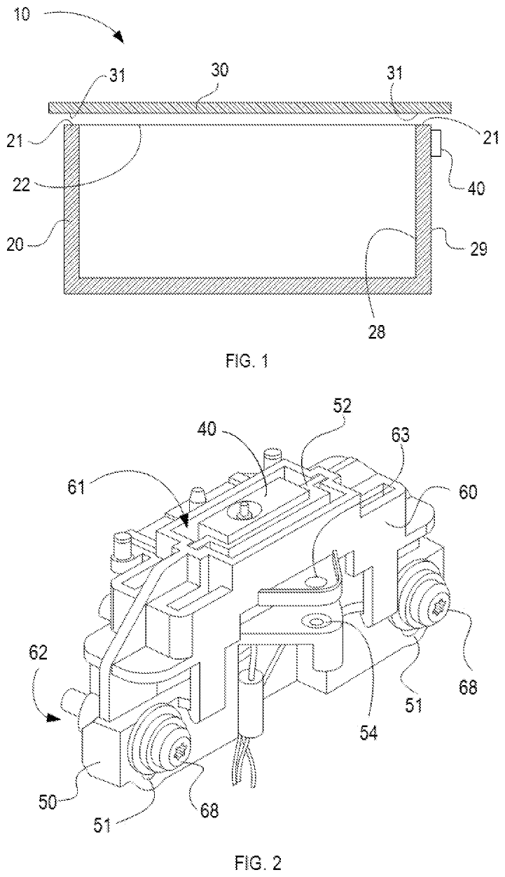

FIG. 2 schematically illustrates a bracket for holding a sensor according to an example of the present disclosure. The bracket comprises a fixed sensor bracket 60 connected to the base unit (not shown in FIG. 2) and an adjustable sensor bracket 50 housing the sensor 40. An opposite view of the adjustable sensor bracket of FIG. 2 is represented in FIG. 3.

In these figures the sensor 40 is connected to the adjustable sensor bracket 50. This connection may be for example a snap fit connection. The adjustable sensor bracket 50 of FIG. 2 is slidably connected to the fixed sensor bracket 60. The adjustable sensor bracket 50 may slide with respect to the fixed sensor bracket 60 and may be connected to the fixed sensor bracket at different positions. In these figures, the fixed sensor bracket 60 comprises a guide 61 in which a protruding portion 52 of the adjustable sensor bracket may be guided. The sensor may be at the protruding portion 52.

The fixed sensor bracket 60 may include a blind hole 62 in which a fastener 68 may be inserted for attaching the fixed sensor bracket to the base unit. The adjustable sensor bracket may include slot 51 in which the fastener 68 may be inserted to attach both the fixed and the adjustable sensor bracket to the base unit through the blind hole 62. The adjustable sensor bracket may thus be attached to the fixed sensor bracket at different heights. The position of the sensor may thus be adjusted with respect to the fixed sensor bracket and, accordingly to the sealing surface of the base unit.

An adjusting element may be used to precisely control the position of the adjustable sensor bracket 50 with respect to the fixed sensor bracket 60. The adjustable sensor bracket 50 of FIG. 2 have a threaded hole 54 to receive an adjusting element (not shown in FIG. 2) inserted in an adjusting hole 63 of the fixed sensor bracket 60. By precisely screwing and unscrewing the adjustable element the height of the adjustable sensor bracket 50 may vary with respect the fixed sensor bracket 60. The position of the sensor with respect to the sealing surface of the base unit may thus be precisely adjusted.

The sensor of FIG. 2 is a contact sensor, e.g. a miniature snap-action switch sensor. The position of the sensor may be adjusted to contact a lid attached to the base unit when the distance between the sealing surface of the lid and the sealing surface of the base unit is below a predetermined distance.

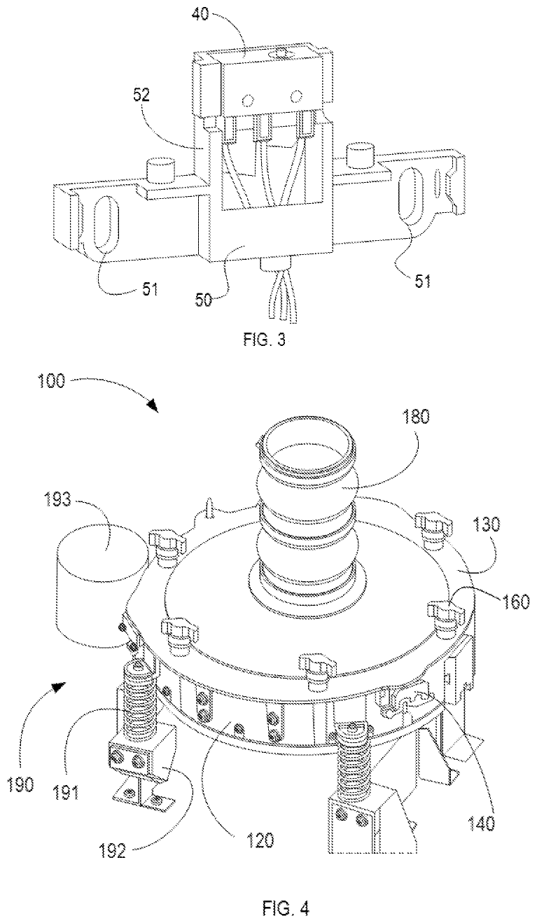

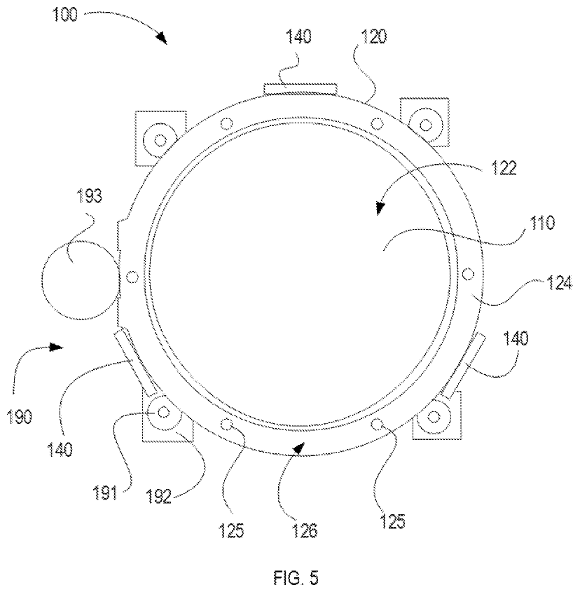

FIG. 4 schematically illustrates an example of a sieve assembly 100 according to the present disclosure. The sieve assembly 100 of FIG. 4 comprises a housing 120 comprising an opening (not shown in FIG. 4) a sieve (not shown in FIG. 4) to sieve powder inside the housing 120 and a lid 130 to close the opening. The sieve assembly further comprises a seal member (not shown in FIG. 4) to be pressed between the lid 130 and the housing 120. In addition, the sieve assembly 100 comprises a plurality of fasteners 160 to connect the lid 130 to the housing 120 such that a distance between the housing 120 and the lid 130 is below a predetermined distance and a plurality of sensors 140 to detect the distance between the housing 120 and the lid 130.

The plurality of fasteners may distribute the force to connect the lid to the housing along the opening. The seal member may thus be more uniformly pressed.

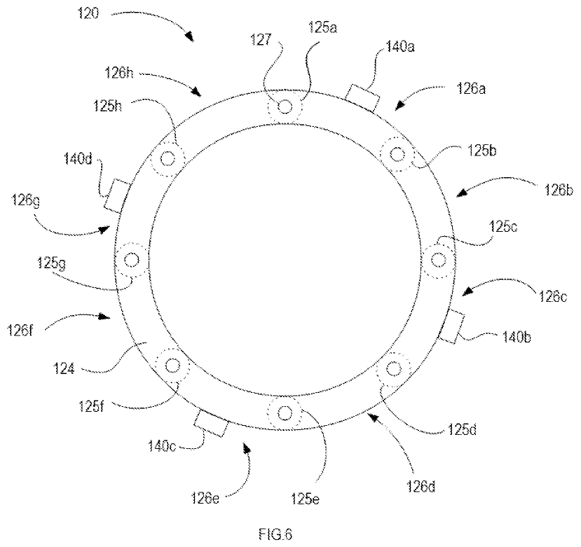

In FIG. 4, the lid 130 is connected to the housing 120 through a plurality of fasteners 160 to close the opening. FIG. 5 schematically illustrates an upper view of the sieve assembly 100 of FIG. 4 in which the lid and the plurality of fasteners are not illustrated. The opening 122 of the housing and the sieve 110 can therefore be seen in FIG. 5.

In some examples, the lid may be hingedly connected to the housing. In these examples, the plurality of fasteners approaches the lid to the housing to seal the connection of the lid and the housing along the whole joint.

The sieve assembly 100 may be used to filter a recovered build material, e.g. powder-based build material, from a 3D printing process. The recovered build material after sieved by the sieve assembly may be used to generate a 3D object.

Powders may be made from particles and may be used as a build material to generate a 3D object. Powders to be sieved in the sieve assembly may comprise plastics, ceramics or metal powders. In some examples, powders may comprise polymers, nylon, crystalline plastics, semi-crystalline plastics, polyethylene (PE), polylactic acid (PLA), acrylonitrile butadiene styrene (ABS), amorphous plastics, polyvinyl alcohol plastic (PVA), polyamide, thermos (setting) plastics, polyamide 11 (PA11), polyamide 12 (PA12), polypropylene (PP) or a combination of any of the above mentioned materials. PA 11 or nylon 11 or polyamide 11 is a polyamide and bioplastic material member of the nylon family of polymers. PA 12 or nylon 12 or polyamide 12 is a thermoplastic and semi-crystalline material of the nylon family of polymers. In some examples, powders may include short fibers that may, for example, have been cut into short lengths from long strands or threads of material.

The sieve assembly may be part of a 3D printing system. A 3D printing system may comprise a 3D printer and a build material management system. The build material management system manages build material. For example, the build material management system may mix fresh build material with recycled build material. In one example, the build material management system may be integrated into a 3D printer. In another example, the build material management system may be separated from the 3D printer.

In some examples, the sieve assembly may be integrated in a material management system. The sieve assembly may be inside a housing of a material management system.

A powder, e.g. recycled build material, may be delivered inside the housing through an inlet 180 on the lid 130. A valve may control the aperture of this inlet 180 to block delivering powder. This powder may fall down and pass through the sieve 110. The sieve 110 may comprise a mesh or an aperture plated to allow passing through the sieve powder particles having a predetermined maximum size and not passing through powder particles greater than the predetermined maximum size. The sieve having a mesh size may be replaced by another sieve having a different mesh size to allow passing particles with a different maximum size. The sieve may further comprise a frame connected to the mesh to attach the sieve to the housing. The sieve assembly may comprise an outlet to unload sieved recycled powder. A valve may control the sieved powder flowing through the outlet.

The sieve assembly 100 of FIG. 4 and FIG. 5 comprises a vibrator mechanism 190 to vibrate the housing 120. Vibrations may assist powder inside the sieve assembly from passing through the sieve 110. Powder particles clogged in the mesh may be reduced. The sieve assembly may vibrate in at least one of the x, y or z axis. The vibrator mechanism 190 may include a motor 193 and springs 191 mounted on supports 192. The springs 191 may connect the housing 120 to the supports 192 allowing the sieve 110 to vibrate. In some examples, the sieve assembly may include an ultrasonic device for enhancing the vibration of the sieve.

The housing may be opened, e.g. the lid 130 may be disconnected from the housing 120, to change the sieve or to clean the sieve by unfastening the plurality of fasteners 160. After changing or cleaning the sieve, the opening 122 may then be closed by the lid 130. A plurality of fasteners may connect the lid to the housing by pressing the lid to the housing. The fasteners may adjust the position of the lid with respect to the housing and the plurality of sensors may detect the distance between the housing and the lid. When the distance between the housing and the lid is below a predetermined distance, leakage of powder may be avoided. A loosened fastener may thus be detected. Accordingly, a sieve mesh inside the housing may be cleaned or changed by a user and the lid may then be attached to the housing in an easy manner while a properly seal may be established.

The connection between the lid and the housing may allow that components of the sieve assembly or other equipments and facilities outside the housing to have a less restrictive category zone or to not be subjected to the ATEX directives. For example, the plurality of sensors may be more cost effective.

In some examples, the sieve assembly may be placed inside a build material management system. Specifications of components of the build material management system with respect to ATEX directives may be laxer.

The connection between the lid 130 and the housing 120 of the sieve assembly 100 may be according to any of the examples of a seal assembly described with respect to FIG. 1-3. The plurality of sensors 140 and the plurality of fasteners 160 of the sieve assembly may be according to any of the examples herein described.

In the example of FIG. 4 and FIG. 5 the plurality of fasteners 160 is a torque limiting knob. These fasteners allow a user to easily connect and disconnect the lid to the housing providing a predetermined torque. Torque limiting knobs are examples of torque limiting screws. In other examples, the plurality of fasteners may be other types of fasteners according to any of the examples herein described.

In these figures, the housing 120 comprises a rim 124 extending around the opening 122. The sealing surface of the housing may be at the rim 124. The rim 124 of these figures has fastening portions 125 to receive the plurality of fasteners and rim portions 126 between two consecutive fastening portions 125. For example, when the plurality of fasteners is a clamp, the fastening portions 125 are the areas of the rim contacted by one of the jaws of the clamp. In these examples, the fastening portions may comprise a protrusion extending outwardly from the housing to receive one of the jaws of the clamp. In other examples, the fastening portions may comprise a threaded hole to screw the fasteners. In the example of FIG. 4 and FIG. 5 the fastening portions 125 comprises threated holes to screw the torque limiting knobs.

In the example of FIG. 4 and FIG. 5 the plurality of sensors 140 is a miniature snap-action switch sensor attached to the housing. These miniature snap-action switch sensors may contact the lid, e.g. a sealing surface of the lid, when the lid is closer to the housing than a predetermined distance. Miniature snap-action switch sensors are examples of contact sensors. A distance between the housing, e.g. a sealing surface of the housing, and the lid, e.g. a sealing surface of the lid, may thus be detected. The plurality of sensors 140 may be mounted on a bracket, e.g. comprising the fixed and the adjustable sensor bracket according to FIG. 2 and FIG. 3. The position of the sensor may therefore be adjusted. The sealing effect of the lid may thus be adjusted, for example depending on the powder size or on the shape or size of the seal member.

In other examples, the plurality of sensors and how the distance between the lid and the housing may be detected may be according to any of the examples herein described. For example, a distance between the lid and the housing of the sieve assembly may be detected according to any of the examples herein described with respect to detect a distance between a lid and the base unit of FIG. 1. The sensor may be a proximity sensor, e.g. an inductive sensor, to measure the distance between the lid and the housing.

In the example of FIG. 4 and FIG. 5 the plurality of sensors 140 are at rim portions 126. In other examples, a sensor of the plurality of sensors is at a rim portion 126 of the rim portions and other sensors of the plurality of sensors may be at or adjacent to the fastening portions 125. In other examples, the plurality of sensors is adjacent to or at the fastening portions 125.

In some examples, the seal member 150 may be attached to the lid. In some other examples, the seal member may be attached to the housing, e.g. to a rim of the housing. In some examples, the seal member may be placed inside a recess at the rim 124 of the housing 120. The seal member may be pressed between the lid and the housing to seal the connection between them. The seal member may be an O-ring. The cross-section may be for example circular or rectangular.

In some examples, the sieve assembly may comprise a controller. The controller may receive a signal from the plurality of sensors indicating the distance detected between the housing and the lid. In some examples, the controller may determine if the lid is correctly attached to the housing to avoid powder leakage. If the distance detected by one of the sensors is above a predetermined distance, the controller may cause the sieve assembly to stall operation. The controller may thus stop the operation of the sieve assembly or preventing to start. The controller may be communicatively coupled to the valve controlling the inlet to prevent powder from entering to the housing. The controller may be communicatively coupled to the vibration mechanism to stop vibration when the lid is not correctly connected to the housing. The inlet may be blocked and the vibration mechanism may be stopped when a distance between the housing and the lid is above the predetermined distance. Powder leakage may thus be prevented.

The controller may be an application controller, for example a controller to control the operation of the sieve assembly. In other examples, the controller may be integrated in a build material management system controller.

In some examples, the controller may send a signal to for example a user interface device to indicate that the connection between the base unit and the lid is not correctly sealed. In some examples, the user integrate device may be integrated in a build material management system.

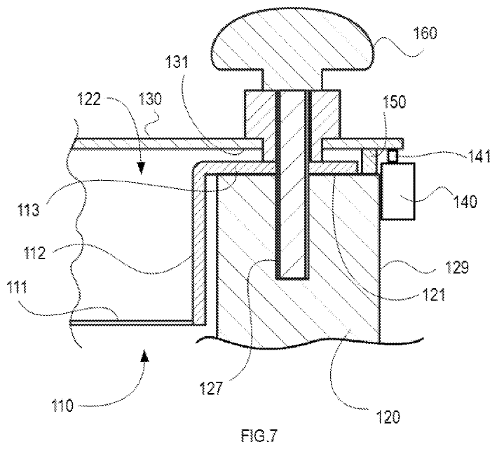

FIG. 6 schematically illustrates a housing 120 and a plurality of sensors 140a-d of an example of a sieve assembly according to the present disclosure. The housing comprises a rim 124 extending around the opening. The rim 124 comprises fastening portions 125a-h and rim portions 126a-h between two consecutive fastening portions 125a-h. The fastening portions 125a-h are to receive the fasteners. In FIG. 6, screws may be inserted and screwed onto threaded holes 127 of the fastening portions 125a-h. In this Figure, a threaded hole 127 is indicated in the fastening portion 125a, however, the other fastening portions of this figure also comprise a threaded hole.

In FIG. 6, the sieve assembly comprises eight fastening portions 125a-h and eight rim portions 126a-h between two consecutive fastener portions. In addition, the sieve assembly of FIG. 6 comprises four sensors 140a-d at rim portions 126a-h. The sensors 140a-d may thus be between the fastener portions 125a-h.

In FIG. 6, the sensors are in alternate rim portions. The sensor 140a is in the rim portion 126a between the fastening portions 125a and 125b. A rim portion 126b is between the fastening portions 125b and 125c and a rim portion 126c is between the fastening portions 125c and 125d. The sensor 140b is at the rim portion 126c. The sensors 140a and 140b are in alternate rim portions 126a and 126c, and not in the rim portion 126b.

In some examples, the sensor 140a may detect if one or both of the fasteners screwed on the fastening portion 125a and fastening portion 125b are loosened. Similarly, the sensor 140b may detect if fasteners received by the fastening portions 125c or 125d are correctly tightened. Tightness of a fastener may be determined by a sensor between this fastener and a consecutive fastener.

In some examples, a distance between the housing and the lid when one of the fasteners is not correctly tightened may be below the predetermined distance that defines the maximum allowable distance between the housing and the lid to prevent powder leakage. The consecutive fastener of this loosened fastener may provide a pressure to maintain the distance between the lid and the housing below the predetermined distance.

For example, the sensor 140a may detect a distance below the predetermined distance when the fastener screwed on the fastening portion 125a is not correctly tightened, i.e. the fastener is loosened. The fastener screwed on the fastening portion 125b may press the lid against the rim 124 to approach the lid to the housing so that the distance between them is below the maximum allowable distance to prevent powder leakage. The sieve assembly may thus operate having a fastener not tightened at a predetermined torque. However, when the fasteners received by the fastening portions 125a and 125b are not tightened at predetermined torque, i.e. are loosened, the sensor 140a may detect that the distance between the lid and the housing is above the maximum distance to avoid powder leakage and the sieve assembly may then be stalled.

The sieve assembly according to FIG. 6 may prevent powder leakage in operation when one fastener is loosened. This sieve assembly may thus be categorized as category zone 21 according to ATEX directives. Specifications of category zone 21 according to ATEX directives involves using devices having a protective system that maintains a predetermined protection level in an event of frequently occurring disturbances or equipment faults which normally have to be taken into account. Accordingly, a sieve assembly in which the plurality of sensors are in alternate rim portions may provide a cost-effective solution while leakage of powder is prevented when the sieve assembly is in operation and one fastener is not correctly tightened.

In other examples, a sensor may be associated with each of the fasteners. Robustness of the sieve assembly may thus be increased. For example, a sensor may be at each rim portion, therefore a loosened fastener may be detected by two sensors. In other examples, the sensors may be adjacent or at the fastening portions. Accordingly, each sensor is dedicated to one fastener. Detection of a potential leakage may be early detected. A sieve assembly having a sensor for each fastener may be categorized as a zone 20 according to ATEX directives. Specifications of category zone 20 according to ATEX directives involves using devices having two independent means of protection or safe even when two faults occur independently of each. When two means of protection, e.g. sensors, are not functioning correctly the sieve assembly may continue operating when the distance determined by the remaining sensors is below a predetermined distance or may stall if the distance determined by one of the remaining sensors is above the predetermined distance to ensure no powder leakage.

FIG. 7 schematically illustrates a cross-sectional view of a portion of a sieve assembly 100 according to one example of the present disclosure. The sieve assembly 100 of this figure, comprises a housing 120 having an opening 122 and a sealing surface 121 extending around the opening 122; a sieve 110 to sieve powder inside the housing 120 and a lid 130 to close the opening 122, the lid 130 comprising a sealing surface 131. The sealing assembly 100 further comprises a seal member 150 to be pressed between the sealing surfaces 121 and 131, a fastener 160 to connect the lid 130 to the housing 120 and to press the seal member 150 between the sealing surfaces 121 and 131. In addition, the sieve assembly 100 comprises a sensor 140 attached to the housing 120 to determine if a distance between the sensor 140 and the sealing surface 131 of the lid is above a predetermined distance and the sieve assembly 100 to stall operation of the sieve assembly if a distance between the sensor 140 and the sealing surface 131 of the lid above a predetermined distance is determined.

In FIG. 7 the lid 130 is connected to the housing 120 through the fastener 160 and the seal member 150 is pressed between the sealing surface 121 of the housing and the sealing surface 131 of the lid. In this figure, the seal member 150 is outwardly with respect to the fastener 160, however in other examples, the seal member 150 may be inwardly with respect to the fastener 160.

In the example of this figure, the sieve 110 comprises a mesh 111 and a frame 112 connected to the mesh 111 to connect the sieve 110 to the housing 120. The frame may comprise a flange 113 to be between the sealing surfaces 121 and 131. In this figure, the fastener 160 passes through a hole on the flange 113 to secure the flange 113 to the housing 120. The flange 113 may thus be pressed by the fastener 160 against the sealing surface 121 of the housing.

The fastener 160 of this figure is a torque limiting knob which is screwed on a threaded hole 127. In some examples, other types of torque limiting screws may be screwed on this threaded hole 127. In other examples, a different type of fastener may be used, e.g. according to any of the fasteners herein disclosed. The sieve assembly of this figure may comprise a plurality of fasteners extending around the opening of the housing.

The sensor 140 of FIG. 7 is a miniature snap-action switch attached to an outer side 129 of the housing 120. The sensor may be attached to the housing through a pair of brackets according to any of the examples herein described, e.g. according to the brackets described in relation to FIGS. 2 and 3.

In this figure, the lid 130 extends over the outer side 129 of the housing 120. The miniature snap-action switch of this figure comprises an actuator 141 contacting the sealing surface 131 of the lid 130 and the miniature snap-action switch is thus determining a distance between this sensor and the sealing surface 131 below a predetermined distance. In this example, the actuator 141 contacts a portion of the sealing surface 131 extending outwardly with respect to the outer surface 129 of the housing 120. The miniature snap-action switch may determine if a distance between the sensor and the sealing surface 131 of the lid is above a predetermined distance when the actuator 141 does not contact this sealing surface 131. Accordingly, when the actuator 141 is not contacting the sealing surface 131, the sensor may determine that the distance between the sensor and the sealing surface 131 of the lid 130 is above a predetermined distance.

The position of the sensor may be adjusted to modify the distance between the sensor and the sealing surface 131 of the lid 130 in which the actuator 141 can contact the sealing surface 131. Determination if the lid is correctly attached to the housing may thus be adjusted to different powders or to different compressibility of the seal member 150. In these examples, the sensor may be positioned at a distance with respect to the lid in such a way that the predetermined distance is the maximum distance in which the actuator contacts the sealing surface 131 of the lid 130.

By determining if a distance between the sensor and the sealing surface of the lid is above a predetermined distance, a distance between the sealing surfaces of the lid and the housing above a distance to avoid powder leakage may be determined by taking into account the position of the sensor with respect to the sealing surface of the housing. Accordingly, the distance between the sealing surface of the lid and the sensor may indicate if the lid is correctly attached to the housing. In these examples, the predetermined distance between the sensor and the sealing surface of the lid may be a distance between the sealing surface of the lid and the sensor in which the sealing surfaces are approached to prevent powder inside the housing from leaving.

In other examples, other types of contact sensors or touch sensors may be used.

In some examples, proximity sensors according to any of the examples herein disclosed may be used. The sensor may measure a distance between the sensor and the sealing surface of the lid. This measured distance may be compared with a predetermined distance to determine if the measured distance is above the predetermined distance.

The sieve assembly of this figure may comprise a plurality of sensors. The sensors may be distributed according to any of the examples herein disclosed. For example, the sensors may be at alternate rim portions.

The sieve assembly may stall operation when the distance between the sensor and the sealing surface of the lid is above a predetermined distance. The operation of the sieve assembly may be stopped or prevented to start. For example, a valve controlling a powder inlet may be closed or a vibration mechanism may be stopped. In some examples, the sieve assembly may send a signal to a user interface device to indicate that the connection between the lid and the housing is not properly sealed. In some examples the user interface device may be integrated in a build material management system. In other examples, the user interface device may be a light.

In some examples, the sieve assembly may comprise a controller to perform these operations. In other examples, an external controller may control the operation of the sieve assembly. An external controller may be a build material management system controller.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

1. A seal assembly comprising:
a base unit comprising an opening and a sealing surface extending around the opening; and
a sensor to detect a distance between the sealing surface of the base unit and a sealing surface of a lid when a fastener is connecting the lid to the base unit.

2. The seal assembly according to claim 1, wherein the sensor is attached to an outer surface of the base unit.

3. The seal assembly according to claim 1, wherein the seal assembly comprises:
a fixed sensor bracket connected to the base unit; and
an adjustable sensor bracket housing the sensor and being slidably connected to the fixed sensor to adjust the position of the sensor with respect the sealing surface of the base unit.

4. The seal assembly according to claim 3, wherein the fixed sensor bracket comprises a guide for guiding the adjustable sensor bracket.

5. The seal assembly according to claim 1, wherein the sensor is a contact sensor.

6. The seal assembly according to claim 1, wherein the sensor is a proximity sensor.

7. A sieve assembly comprising:
a housing comprising an opening;
a sieve to sieve powder inside the housing;
a lid to close the opening;
a seal member to be pressed between the lid and the housing;
a plurality of fasteners to connect the lid to the housing such that a distance between the housing and the lid is below a predetermined distance; and
a plurality of sensors to detect the distance between the housing and the lid.

8. The sieve assembly according to claim 7, wherein the housing comprises a rim around the opening, the rim comprising fastening portions to fasten the plurality of fasteners and rim portions between two consecutive fastening portions.

9. The sieve assembly according to claim 8, wherein a sensor of the plurality of sensors is at a rim portion of the rim portions.

10. The sieve assembly according to claim 9, wherein the plurality of sensors is in alternate rim portions.

11. The sieve assembly according to claim 8, wherein a sensor of the plurality of sensors is adjacent to or at a fastening portion of the fastening portions.

12. The sieve assembly according to claim 7, wherein the plurality of fasteners is a torque limiting screw.

13. A sieve assembly comprising:
a housing comprising an opening and a sealing surface extending around the opening;
a sieve to sieve powder inside the housing;
a lid to close the opening, the lid comprising a sealing surface;
a seal member, the seal member to be pressed between the sealing surfaces;
a fastener to connect the lid to the housing and to press the seal member between the sealing surfaces;
a sensor attached to the housing to determine if a distance between the sensor and the sealing surface of the lid is above a predetermined distance; and
the sieve assembly to stall operation of the sieve assembly if a distance between the sensor and the sealing surface of the lid above a predetermined distance is determined.

14. The sieve assembly according to claim 13, wherein the sieve comprises:
a mesh; and
a frame connected to the mesh, wherein the frame comprises a flange to be between the sealing surfaces.

15. The sieve assembly according to claim 13, wherein the sieve assembly is to send a signal to a user interface device if a distance between the sensor and the sealing surface of the lid above a predetermined distance is determined.
